(19) United States
(12) Patent Application Publication
(10) Pub. No.: US 2010/0104281 A1
(43) Pub. Date: Apr. 29, 2010

(54) Selecting Regeneration Nodes During Path Computation

(76) Inventors: Abinder S. Dhillon, Allen, TX (US); Snigdho C. Bardalai, Plano, TX (US); Sanjay Gera, Richardson, TX (US); Fredrick S. Gruman, Plano, TX (US); Vibha Sarin, Murphy, TX (US)

Correspondence Address: BAKER BOTTS L.L.P., 2001 ROSS AVENUE, SUITE 600, DALLAS, TX, 75201-2980, US

(21) Appl. No.: 12/260,687

(22) Filed: Oct. 29, 2008

(51) Int. Cl. H04J 14/00

(52) U.S. Cl. 398/45

(57) ABSTRACT

According to one embodiment, regeneration information indicating the optical reachability of a set of regeneration nodes is managed. Candidate paths from a source node to a destination node are calculated according to the regeneration information. The destination node is optically reachable from the source node along a candidate path. At least one candidate path is selected from the candidate paths.

### TECHNICAL FIELD

This invention relates generally to the field of communications and more specifically to selecting regeneration nodes during path computation.

### BACKGROUND

In optical networks, an optical signal travels along a path from a source to a destination. If the destination is not optically reachable from the source, the signal can be regenerated. Regeneration nodes along the path may regenerate the signal.

### SUMMARY OF THE DISCLOSURE

In accordance with the present invention, disadvantages and problems associated with previous techniques for selecting regeneration nodes in an optical network may be reduced or eliminated.

According to one embodiment, regeneration information indicating the optical reachability of a set of regeneration nodes is managed. Candidate paths from a source node to a destination node are calculated according to the regeneration information. The destination node is optically reachable from the source node along a candidate path. At least one candidate path is selected from the candidate paths.

Certain embodiments of the invention may provide one or more technical advantages. A technical advantage of one embodiment may be that regeneration information indicating the optical reachability of regeneration nodes may be distributed among nodes. Distributing the regeneration information allows the nodes to select regeneration nodes during path calculation.

Certain embodiments of the invention may include none, some, or all of the above technical advantages.

One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of an optical network for which regeneration nodes may be selected during path computation;

FIG. 2 illustrates one embodiment of a path calculator that may select regeneration nodes during path computation;

FIG. 3 illustrates one example of a method that may be performed by a path calculator to select regeneration nodes during path computation; and

FIG. 4 illustrates another example of a method that may be performed by a path calculator to select regeneration nodes during path computation.

### DETAILED DESCRIPTION OF THE DRAWINGS

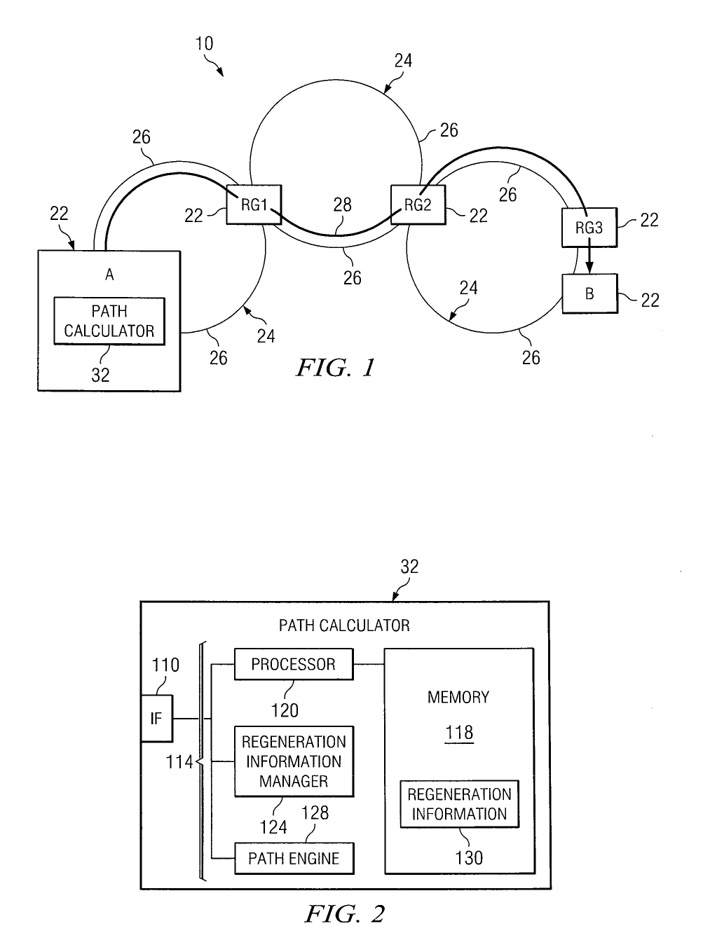

Embodiments of the present invention and its advantages are best understood by referring to FIGS. 1 through 4 of the drawings, like numerals being used for like and corresponding parts of the various drawings.

FIG. 1 illustrates one embodiment of an optical network 10 for which regeneration nodes may be selected during path computation. In the embodiment, network 10 includes ring networks 24 of nodes 22 (such as regeneration nodes RG, source node A, and source node B), and spans 26. In certain embodiments, regeneration information indicating the optical reachability of regeneration nodes RG may be distributed among nodes 22 of network 10. Distributing the regeneration information allows nodes 22 to select regeneration nodes RG during path calculation.

In particular embodiments, network 10 represents a communication network that allows components, such as nodes 22, to communicate with other components. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of any of the preceding.

In particular embodiments, network 20 communicates information through signals. A signal may comprise an optical signal transmitted as light pulses. As an example, an optical signal may have a frequency of approximately 1550 nanometers and a data rate of 10, 20, 40, 100, or over 100 gigabits per second (Gbps). A signal may comprise a synchronous transport signal (STS) that communicates information in packets. Information may include voice, data, audio, video, multimedia, control, signaling, and/or other information.

In particular embodiments, network 10 may include one or more ring networks 24. According to one embodiment, a ring network may utilize protocols such as Resilient Packet Ring (RPR) protocols, according to which packets are added, passed through, or dropped at each network node 22. Ring network 24 may utilize any suitable routing technique, such as Generalized Multi-Protocol Label Switching (GMPLS) techniques. A ring network may utilize any suitable transmission technique, such as wavelength division multiplexing (WDM) techniques.

In particular embodiments, network 10 includes network nodes 22 (illustrated as A, B, RG1, RG2, and RG3) and spans 26. In particular embodiments, spans 26 represent optical fibers configured to transmit an optical signal.

Network nodes 22 may be any suitable device configured to route packets through, to, or from ring network 20. Examples of network elements include routers, switches, wavelength division multiplexers (WDMs), access gateways, endpoints, softswitch servers, trunk gateways, access service providers, Internet service providers, a network management system, or other device configured to route packets through, to, or from ring network 20.

A path 28 of spans 26 may go from source node 22, through zero, one, or more nodes 22, and to a destination node 22. In the illustrated embodiment, a path 28 goes from node A, through nodes RG1, RG2, and RG3, and to node B.

Optical reachability describes the ability of an optical signal to travel from one node 22 to another node 22 along a path 28 without unacceptable degradation. A first node 22 may be optically reachable by a second node 22 along a path 28 if a signal from the first node can travel along the path 28 to the second node 22 without unsatisfactory degradation.

In particular embodiments, network nodes 22 include regeneration nodes (illustrated as RG1, RG2, and RG3) that regenerate a signal traveling from source node B to destination node B such that the signal reaches destination node B in satisfactory condition. A regeneration node may be provisioned with a regenerator identifier. In the example, the identifiers for nodes RG1, RG2, and RG3 may be RG1, RG2, and RG3, respectively.

In particular embodiments, regeneration information describes regeneration nodes of a network 10, and may use regenerator identifiers to identify the regeneration nodes. The information may include a list of regeneration nodes of network 10, such as RG1, RG2, and RG3.

In particular embodiments, regeneration information indicates the regeneration nodes that are optically reachable by particular nodes 22 (such as non-regeneration nodes or other regeneration nodes). For example, regeneration information may indicate regeneration nodes 22 that are optically reachable by a source node 22, another regeneration node 22, and/or a destination node 22. In one example, the list of optically reachable regeneration nodes for node A may include RG1 and RG2, and the list for node B may include RG2 and RG3.

A regeneration node may place regeneration information describing nodes 22 that it can reach into a reachability matrix. In particular embodiments, the matrix may be expressed as [{N₁, X₁}, . . . , {Nᵢ, Xᵢ}, . . . , {Nₙ, Xₙ}], where N represents the identifier of the optically reachable node 22 and X represents the cost to reach a given destination. In the example, regeneration node RG1 can reach RG2 and RG3, so RG1 generates a matrix that includes [{RG2,1}, {RG3,4}]. RG2 can reach RG1 and RG3, so RG2 generates a matrix that includes [{RG1,1}, {RG3,1}].

In particular embodiments, a list of regeneration nodes reachable by a node 22 may be sorted based on the length of the paths between the regeneration nodes and the node 22. For example, the shorter paths may be placed before, and may have a higher priority than, the longer paths.

In particular embodiments, a node 22 or other apparatus may manage regeneration information. Node 22 (such as source node A) may collect and distribute information indicating regeneration nodes that optically reachable by the node 22. Node 22 may receive and distribute regeneration information indicating regeneration nodes that are optically reachable by another node 22 (such as destination node B). Node 22 may distribute and/or receive the information in a Shortest Path First-Traffice Engineering (OSPF-TE) link-state advertisement (LSA). In particular embodiments, a node 22 may manage regeneration information by placing the information into a data structure, such as a reachability matrix, which may then be distributed.

In particular embodiments, a node 22 may include a path calculator 32. A path calculator 32 manages regeneration information and calculates paths from a source node 22 to a destination node 22. In particular examples, path calculator 32 may calculate a number of candidate paths according to the regeneration information and select a candidate path. The operations of path calculator 32 may be performed by one or more apparatuses, such as by a node 20, a network management system, and/or other apparatus.

A component of network 10 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

FIG. 2 illustrates one embodiment of path calculator 32 that may select regeneration nodes 22 during path calculation. The operations of path calculator 32 may be performed by one or more apparatuses, such as by a node 20, a network management system, and/or other apparatus. In the illustrated embodiment, path calculator 32 includes an interface (IF) 110, logic 114, and memory 118. Logic 114 includes a processor 120, a regeneration information manager 124, and a path engine 128.

In particular embodiments, regeneration information manager 124 manages regeneration information 130. For example, regeneration information manager 124 may collect and distribute regeneration information 130. Regeneration information manager 124 may distribute and/or receive the information in a Shortest Path First-Traffice Engineering (OSPF-TE) link-state advertisement (LSA). Regeneration information manager 124 may manage regeneration information 130 by placing the information into a data structure, such as a matrix, which may then be distributed.

Path engine 128 may calculate a path 28 in any suitable manner. In particular embodiments, path engine 128 may calculate several candidate paths and then select a path 28 for use. In particular embodiments, a destination node B may be optically reachable from a source node A along a candidate path.

In particular embodiments, path engine 128 calculates paths by identifying regeneration nodes RG that are optically reachable by source node A and by destination node B. Path engine 128 then calculates, for each regeneration node RG, a candidate path from source node A through the regeneration node RG to destination node B.

In particular embodiments, path engine 128 may establish that there is no common regeneration node that is optically reachable by source node A and destination node B. Path engine 128 calculates intermediate paths between a first regeneration node that is optically reachable from source node A and a second regeneration node that is optically reachable from destination node B. Path engine 128 then calculates candidate paths from the one or more intermediate paths, where each candidate path goes from the source node, through the first regeneration node, through the intermediate path, through the second regeneration node, and to the destination path.

Path engine 128 may select a path in any suitable manner. In particular embodiments, path engine 128 may select the shortest candidate path. In particular embodiments, path engine 128 may check that no candidate path has overlapping nodes, that is, nodes that the path traverses more than once.

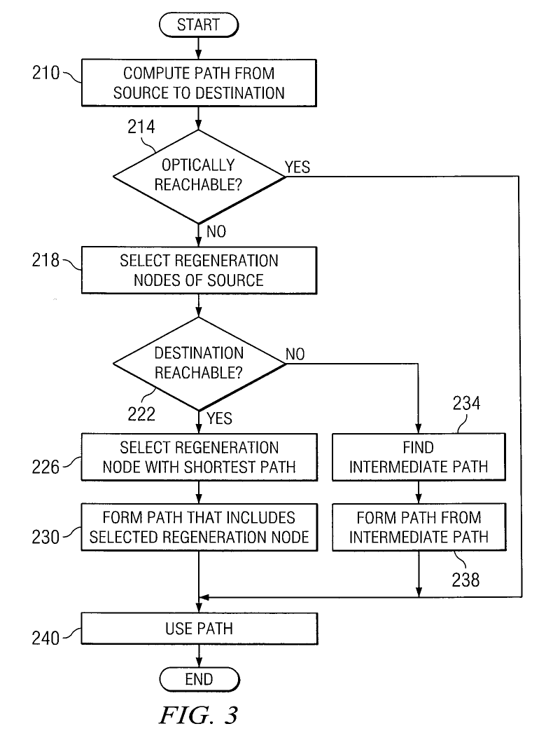

FIG. 3 illustrates one example of a method that may be performed by path calculator 32 to select regeneration nodes RG during path computation. The method begins at step 210, where path computer 32 computes a path from source node A to destination node B.

Destination node B may be optically reachable from source node A via the computed path at step 214. If the destination node B is not optically reachable at step 214, the method proceeds to step 218. Path calculator 32 selects a set of one or more regeneration nodes that are optically reachable by source node A at step 218. The regeneration nodes may be selected from the regeneration node list of source node A.

Destination node B may be reachable via a regeneration node of the set at step 222. If destination node B is optically reachable at step 222, the method proceeds to step 226. The regeneration node that forms the shortest path between source node A and destination node B is selected at step 226. A path that includes source node A, the selected regeneration node, and destination node B is formed at step 230. The method then proceeds to step 240.

If destination node B is not optically reachable at step 222, the method proceeds to step 234. An intermediate path is found at step 234. An intermediate path is a path that goes through a regeneration node that is optically reachable by source node A and a regeneration node that is optically reachable by destination node B. A path is formed from the intermediate path at step 238. The path may include source node A, the intermediate path, and destination node B. The method then proceeds to step 240.

If destination node B is optically reachable at step 214, the method proceeds directly to step 240. The path that has been calculated and/or selected is used at step 240. The method then ends.

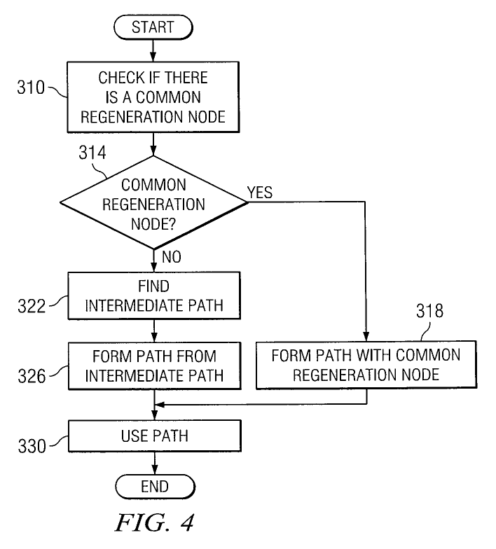

FIG. 4 illustrates another example of a method that may be performed by path calculator 32 to select regeneration nodes during path computation. The method begins at step 310, where path calculator 32 checks to see if there is a common regeneration node between source node A and destination node B. A common regeneration node is a node that is optically reachable by both source node A and destination node B.

If there is a common regeneration node at step 314, the method proceeds to step 318. A path is formed with a common regeneration node at step 318. The path includes the source node A, the common regeneration node, and the destination node B. The method then proceeds to step 330.

If there is no regeneration node at step 314, the method proceeds to step 322. An intermediate path is found at step 322. A path with the intermediate path is formed at step 326. The path may include the source node, the intermediate path, and the destination node B. The method then proceeds to step 330. The path is used at step 330. The method then ends.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic. As used in this document, “each” refers to each member of a set or each member of a subset of a set.

Modifications, additions, or omissions may be made to the methods described herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A computer-readable medium having computer-executable instructions, when executed by a computer configured to:
manage regeneration information indicating optical reachability of a set of regeneration nodes;
calculate one or more candidate paths from a source node to a destination node according to the regeneration information, the destination node optically reachable from the source node along each candidate path of the one or more candidate paths; and
select at least one candidate path from the one or more candidate paths.

2. The computer-readable medium of claim 1, configured to calculate the one or more candidate paths by:
identifying one or more regeneration nodes of the set of regeneration nodes that are optically reachable by the source node and by the destination node; and
for each regeneration node of the one or more regeneration nodes, calculating a candidate path from the source node through the each regeneration node to the destination node.

3. The computer-readable medium of claim 1, configured to calculate the one or more candidate paths by:
establishing that there is no common regeneration node that is optically reachable by the source node and the destination node;
calculating one or more intermediate paths between a first regeneration node that is optically reachable from the source node and a second regeneration node that is optically reachable from the destination node; and
calculating the one or more candidate paths from the one or more intermediate paths.

4. The computer-readable medium of claim 1, configured to select the at least one candidate path by:
selecting the shortest candidate path of the subset.

5. The computer-readable medium of claim 1, configured to:
check that no candidate path has overlapping nodes.

6. The computer-readable medium of claim 1, configured to manage the regeneration information by:
distributing the regeneration information indicating one or more regeneration nodes that are optically reachable by the source node.

7. The computer-readable medium of claim 1, configured to manage the regeneration information by:
receiving the regeneration information indicating one or more regeneration nodes that are optically reachable by the destination node.

8. The computer-readable medium of claim 1, configured to manage the regeneration information by:
placing the regeneration information in a data structure, the regeneration information indicating:
a first set of one or more regeneration nodes that are optically reachable by the source node; and
a second set of one or more regeneration nodes that are optically reachable by the destination node.

9. The computer-readable medium of claim 1, configured to manage the regeneration information by:
distributing the regeneration information in an Open Shortest Path First-Traffice Engineering (OSPF-TE) link-state advertisement (LSA).

10. The computer-readable medium of claim 1, configured to manage the regeneration information by:
distributing the regeneration information, the regeneration information indicating:
a first set of one or more regeneration nodes that are optically reachable by the source node; and
a second set of one or more regeneration nodes that are optically reachable by the destination node.

11. A method comprising:
managing regeneration information stored in computer-readable medium, the regeneration information indicating optical reachability of a set of regeneration nodes;
calculating, by an apparatus, one or more candidate paths from a source node to a destination node according to the regeneration information, the destination node optically reachable from the source node along each candidate path of the one or more candidate paths; and
selecting, by the apparatus, at least one candidate path from the one or more candidate paths.

12. The method of claim 11, the calculating the one or more candidate paths further comprising:
identifying one or more regeneration nodes of the set of regeneration nodes that are optically reachable by the source node and by the destination node; and
for each regeneration node of the one or more regeneration nodes, calculating a candidate path from the source node through the each regeneration node to the destination node.

13. The method of claim 11, the calculating the one or more candidate paths further comprising:
establishing that there is no common regeneration node that is optically reachable by the source node and the destination node;
calculating one or more intermediate paths between a first regeneration node that is optically reachable from the source node and a second regeneration node that is optically reachable from the destination node; and
calculating the one or more candidate paths from the one or more intermediate paths.

14. The method of claim 11, the selecting the at least one candidate path further comprising:
selecting the shortest candidate path of the subset.

15. The method of claim 11, further comprising:
checking that no candidate path has overlapping nodes.

16. The method of claim 11, the managing the regeneration information further comprising:
distributing the regeneration information indicating one or more regeneration nodes that are optically reachable by the source node.

17. The method of claim 11, the managing the regeneration information further comprising:
receiving the regeneration information indicating one or more regeneration nodes that are optically reachable by the destination node.

18. The method of claim 11, the managing the regeneration information further comprising:
placing the regeneration information in a data structure, the regeneration information indicating:
a first set of one or more regeneration nodes that are optically reachable by the source node; and
a second set of one or more regeneration nodes that are optically reachable by the destination node.

19. The method of claim 11, the managing the regeneration information further comprising:
distributing the regeneration information in an Open Shortest Path First-Traffice Engineering (OSPF-TE) link-state advertisement (LSA).

20. The method of claim 11, the managing the regeneration information further comprising:
distributing the regeneration information, the regeneration information indicating:
a first set of one or more regeneration nodes that are optically reachable by the source node; and
a second set of one or more regeneration nodes that are optically reachable by the destination node.

21. A system comprising:
means for managing regeneration information stored in computer-readable medium, the regeneration information indicating optical reachability of a set of regeneration nodes;
means for calculating, by an apparatus, one or more candidate paths from a source node to a destination node according to the regeneration information, the destination node optically reachable from the source node along each candidate path of the one or more candidate paths; and
means for selecting, by the apparatus, at least one candidate path from the one or more candidate paths.
